(19) United States
(12) Patent Application Publication
(10) Pub. No.: US 2023/0169061 A1
(43) Pub. Date: Jun. 1, 2023

(54) SYSTEM AND METHOD FOR SHARING A LOCAL EVENT

(71) Applicant: Matthew Heuman, Kitchener (CA)

(72) Inventor: Matthew Heuman, Kitchener (CA)

(21) Appl. No.: 17/994,193

(22) Filed: Nov. 25, 2022

Related U.S. Application Data
(60) Provisional application No. 63/283,386, filed on Nov. 26, 2021.

(51) Int. Cl. G06F 16/23; H04W 4/021

(52) U.S. Cl. CPC G06F 16/235; H04W 4/021; H04L 9/50

(57) ABSTRACT

A method of sharing a local event includes receiving an indication that a mobile device has signed into a location-dependent virtual event space associated with the local event; receiving an indication that the mobile device has shared a media asset via the location-dependent virtual event space; receiving the media asset and an associated asset non-fungible token; storing the media asset in a collection that includes other media assets from the plurality of mobile devices; and providing access to the collection to an owner of at least one asset non-fungible token of the plurality of non-fungible assets tokens. A system for sharing a local event includes a plurality of mobile devices at a local event, a data storage device, and at least one processor configured to receive media assets and asset non-fungible tokens from the plurality of mobile devices, generate a collection, and provide access to the collection to owners of the asset non-fungible tokens.

### CROSS REFERENCE TO RELATED PATENT APPLICATIONS

The application claims the benefit of U.S. Provisional Application No. 63/283,386, filed on Nov. 26, 2021. The complete disclosure of U.S. Provisional Application No. 62/283,386 is hereby incorporated herein by reference for all purposes.

### FIELD

The disclosure relates to event sharing, and particularly to a system and method for sharing media assets, such as photos and videos, capturing a view of a local event.

### BACKGROUND

A digital media asset can be scanned to produce a hash value of the data values used to encode the digital media asset on a digital device. This hash value can be assigned meta data values that function as unique identifiers for the hash value. This combination of a hash value and meta data values is frequently described as a non-fungible token (NFT). An NFT may be transferred between owners, with transactions recorded in a ledger such as on a blockchain to provide a mechanism to demonstrate ownership of the digital media asset.

Pictures, videos, and other digitally stored media assets can be represented by a NFT, and the NFT may be purchased, exchanged, or stored by users. Purchasing a NFT of a digital media asset may provide an element of exclusivity and uniqueness to the digital media asset.

However, the hashed value incorporated into the transferrable NFT is simply a string of characters and not the digital media asset itself. Even though the digital media asset is encrypted to produce the hash value, the digital media asset itself may still reside in a data storage device, either remote (e.g., in a cloud environment) or locally (e.g., on a local computer or data storage device).

These digital media assets are still vulnerable to theft, piracy or copying. Therefore, a need exists in the field for additional security for digital media assets.

### SUMMARY

According to a first aspect, there is provided a method of sharing a local event, comprising receiving for each mobile device of a plurality of mobile devices an indication that the mobile device has signed into a location-dependent virtual event space associated with the local event; receiving for each mobile device of the plurality of mobile device an indication that the mobile device has shared a media asset via the location-dependent virtual event space; receiving the plurality of media assets and a plurality of asset non-fungible tokens, each asset non-fungible token of the plurality of asset non-fungible tokens representing a media asset of the plurality of media assets, each asset non-fungible token indicative of the media asset it represents and the mobile device from which it originated; storing the plurality of media assets in a collection; and, providing access to the collection to an owner of at least one asset non-fungible token of the plurality of non-fungible assets tokens.

In some embodiments, the indication that the mobile device has shared the media asset via the location-dependent virtual event space includes an indication that the mobile device was communicatively coupled via a local wireless connection directly to another mobile device that was signed into the location-dependent virtual event space.

The local wireless connection may be a Bluetooth connection.

Each of the asset non-fungible tokens of the plurality of asset non-fungible tokens may incorporate information derived from the media asset it represents.

Each asset non-fungible token may also be indicative of the time and place that the media asset it represents was created.

The owner of the at least one asset non-fungible token may be the account holder of a user account controlling the mobile device when the associated media asset was created or a user to whom the at least one asset non-fungible token was transferred by a previous owner.

Ownership records of the asset non-fungible token may be stored in a blockchain.

The content of the collection may be viewed when accessed, but cannot be copied.

The media assets may not be copiable via download or screenshot.

The method may further comprise generating a collection non-fungible token representing the collection.

The collection non-fungible token may include information derived from each of the asset non-fungible tokens.

According to a second aspect, there is provided a system for sharing a local event, comprising: a plurality of mobile devices, each configured to: sign into a location-dependent virtual event space associated with the local event, connect to others of the plurality of mobile devices directly via a local network at the local event, create a media asset capturing a view of the local event, and create an asset non-fungible token representing the media asset and indicative of the media asset and the mobile device that created the media asset; a data storage device; and, at least one processor, configured to: receive for each mobile device of the plurality of mobile devices an indication that the mobile device has signed into the location-dependent virtual event space, receive for each mobile device of the plurality of mobile device an indication that the mobile device has shared the media asset via the location-dependent virtual event space, receive the media asset and the asset non-fungible token from each mobile device of the plurality of mobile devices, store the media assets of the plurality of mobile devices on the data storage device in a collection, and, provide access to the collection to an owner of at least one asset non-fungible token of the plurality of asset non-fungible tokens.

In some embodiments, the indication that the mobile device has shared the media asset via the location-dependent virtual event space includes an indication that the mobile device was communicatively coupled via a local wireless connection directly to another mobile device that was signed into the location-dependent virtual event space.

The local wireless connection may be a Bluetooth connection.

Each of the asset non-fungible tokens of the plurality of asset non-fungible tokens may incorporate information derived from the media asset it represents.

Each asset non-fungible token is may also be indicative of the time and place that the media asset it represents was created.

The owner of the at least one asset non-fungible token may be the account holder of a user account controlling the mobile device when the associated media asset was created or a user to whom the at least one asset non-fungible token was transferred by a previous owner.

Ownership records of the asset non-fungible token may be stored in a blockchain.

The content of the collection may be viewed when accessed, but cannot be copied.

The media assets may not be copyable via download or screenshot.

The at least one processor may be further configured to generate a collection non-fungible token representing the collection.

The collection non-fungible token may include information derived from each of the asset non-fungible tokens.

### BRIEF DESCRIPTION OF THE DRAWINGS

The drawings included herewith are for illustrating various examples of systems, methods, and apparatus of the present specification. In the drawings:

FIG. 1 is a schematic diagram of a system for sharing a local event, showing a user mobile device connecting to a location-dependent virtual event space;

FIG. 2 is a schematic diagram of a system for sharing a local event, showing a plurality of user mobile devices coupled to one another via a local network;

FIG. 3 is a schematic diagram of a system for sharing a local event, showing the plurality of user mobile devices sharing a plurality of digital media assets via the local network;

FIG. 4 is a schematic diagram of a collection incorporating the plurality of digital media assets;

FIG. 5 is a schematic diagram of a user mobile device accessing the collection; and,

FIG. 6 is a flow chart of an event sharing method.

### DETAILED DESCRIPTION

Various apparatus or processes will be described below to provide an example of each claimed embodiment. No example described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatus or processes described below.

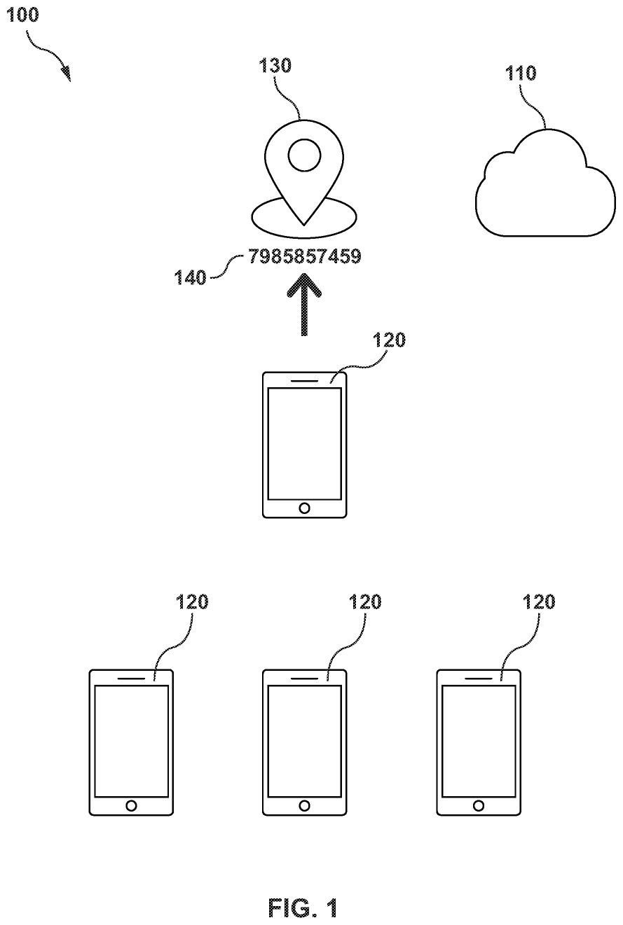

An exemplary system 100 for sharing a local event is illustrated in FIG. 1.

In some embodiments, the user attends a location dependent event and signs into the service using a CODE/QR CODE/INVITE LINK. In some embodiments, when the user completes the sign in, the event shares a data value with the user which is stored locally on the device.

The exemplary system 100 of FIG. 1 includes a data server 110 (i.e., at least one processor and at least one data storage device, which may be remote and/or local, and which may be a plurality of distributed processors and/or a plurality of distributed data storage devices) which stores device data values identifying a user mobile device, user account details, user mobile device interaction details, and/or digital media assets.

The data server 110 may also broker connections and digital media asset transfers between mobile devices (e.g., over a network protocol), such as if a digital media asset is too large to be readily transferred directly via a local network. The data server 110 may operate via a standard web application. As exemplified, the data server 110 may be a remote data server, such as a remote and distributed data server operating as a cloud server. The data server 110 may manage resources of and connections between a plurality of user mobile devices 120 of users attending an event.

In some embodiments, the data server 110 only serves the digital media asset between user mobile device once a proximity detection signal has been established between the user mobile devices. In other words, the brokerage of the connection is only available between user mobile devices that are in close proximity, but the data server 110 can then serve the digital media asset stored on the data server 110 to the recipient user mobile device via an online network (e.g., via local wi-fi or internet-based network protocols using the user mobile devices' wireless modem features).

In some embodiments, the data server 110 also encrypts and tokenizes a final aggregated collection, such as a collection of digital media assets, device data values, user mobile device interaction details, and user account details, to generate a collection NFT once the local event is concluded. The data server 110 may also store a final NFT representing the collection, which may be shared with users.

As exemplified in FIG. 1, users bring the user mobile devices 120 (e.g., portable computing devices such as smartphones or tablets) to a local event (e.g., a hockey game at an ice rink, or a get-together at a restaurant). User mobile devices 120 sign into a location-dependent virtual event space 130 associated with the local event. As exemplified, the user mobile devices 120 may sign into the location-dependent virtual event space 130 using an EVENT CODE 140, although it will be understood that other sign in operations may be used. The location-dependent virtual event space 130 may have an opening and closing time associated to the EVENT CODE 140.

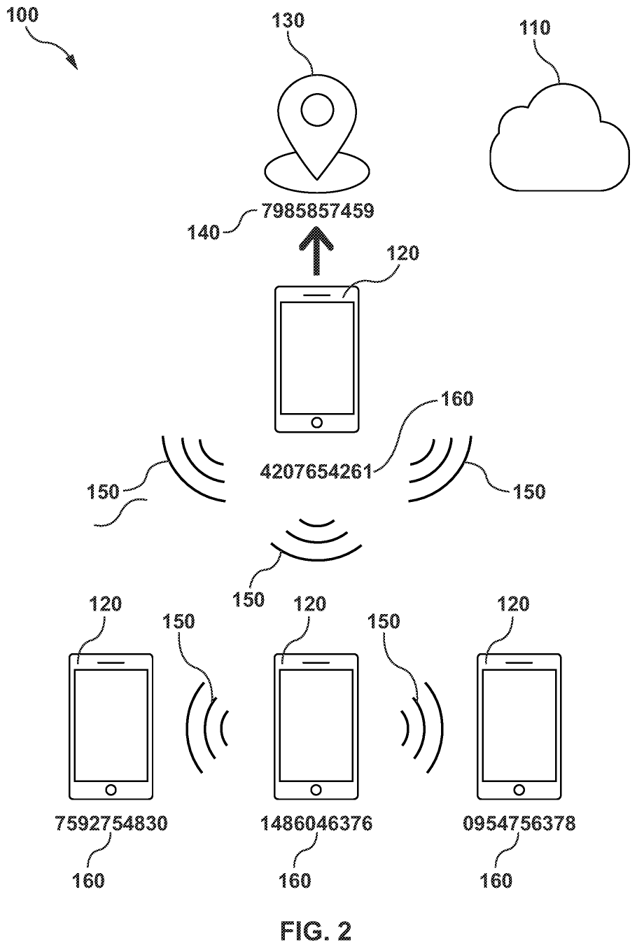

As exemplified in FIG. 2, signing in using the EVENT CODE 140 is used by a user mobile device 120 to communicatively couple (e.g., pair) with other user mobile devices 120 at the event using close proximity transmissions 150. For example, the user mobile devices 120 may be paired with one another via Bluetooth™.

In some embodiments, all users within close proximity are paired and connected to each other by using the Event Data Value (e.g., event code) as an authorization mechanism. This event data value is stored on each user mobile device and on a cloud data server for redundancy. Each User has a unique ID data value associated to the user mobile device and user account. These accounts (e.g., unique ID data values) are also shared when users are connected together.

A user mobile device 120 may include a processor with random access memory (RAM), and includes a close proximity detection receiver and transceiver, and a local data storage device. The user mobile device 120 runs a mobile application that a user of the user mobile device 120 may use to into a location-dependent virtual event space. The mobile application may also generate encryption, store and exchange device data values, store and exchange user account details, store user mobile device interaction details, store digital media assets, and/or exchange digital media assets with other locally-connected (i.e., directly connected via a local network) user mobile devices.

Each user mobile device 120 contains unique device data values hardcoded to the device firmware. The device data values may be associated with a user account, digital asset, participation in a location-dependent virtual event space, device interaction (e.g., sharing and viewing of the exchanged digital media assets), and/or the final collection NTF. The device data values may be used to attribute ownership (e.g., to attribute full or fractional ownership of a digital media asset and/or the final collection to a user of the user mobile device).

As exemplified in FIG. 2, each user mobile device 120 may be associated with a unique USER CODE 160. For example, a user code 160 may be generated when a user signs into the location-dependent virtual event space 130 (e.g., to permit connections, generate encryption of digital media assets, and assign attribution of digital media assets when exchanged between user mobile devices 120).

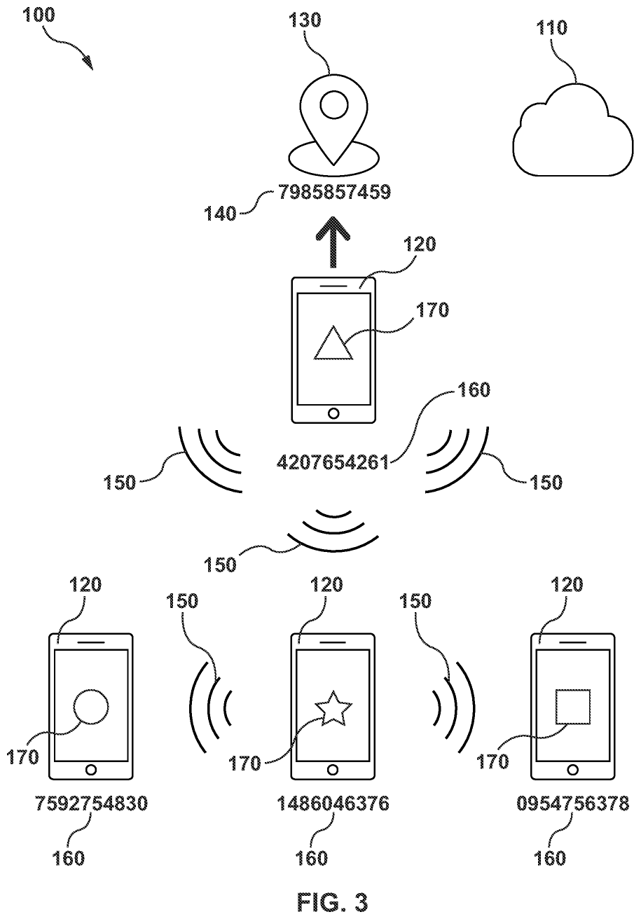

As exemplified in FIG. 3, the user mobile devices 120 are used to create digital media assets 170.

In some embodiments, users can take real time images, videos, audio recording or other digital assets which are shared with the connected event users in real time using close proximity data transfers. In some embodiments, the cloud data server brokers any connection that exceeds the bandwidth limit of data size for these transfers as a redundancy. In some embodiments, each user's digital asset is encrypted and stored locally but also sent to the cloud data server for storage.

The digital media assets 170 may be videos, audio recordings, and/or pictures. These digital media assets 170 may be created and/or stored on the user mobile device 120. Each digital media asset 170 is encrypted using the mobile application to derive a hashed value associated uniquely to that digital media asset 170.

In other words, the digital media asset 170 is created and stored on a user mobile device 120 running a mobile application which is operable to encode the digital media asset 170 to derive a hash value (i.e., a string of characters) that uniquely identifies the digital media asset 170 and is operable to store this hash value locally on the user mobile device 120. For example, the hash value may be created by converting each pixel of a digital media image to an integer, and adding the integers of all the pixels of the digital media image into a final sum to produce a string of data. The hash value is combined with meta data, such as additional data derived from the mobile application and attributes of the user mobile device 120 to produce a unique asset NTF for the digital media asset.

As exemplified in FIG. 3, digital media assets 170 may be shared between user mobile devices 120 that are signed into the location-dependent virtual event space 130 and communicatively coupled via close proximity transmissions 150 (i.e., communicatively coupled directly to one another via a local network). The combination of close proximity transmissions 150 and a location-dependent virtual event space 130 may provide greater control over access to the digital media assets (e.g., for greater peace of mind for users attending the local event). The data server 110 stores digital media assets 170 produced by the mobile applications of the user mobile devices 120 while signed into the location-dependent virtual event space 130.

While the user mobile devices 120 may transfer the digital media asset 170 directly between one another via the close proximity transmissions 150, for some digital media assets 170 the close proximity transmissions 150 may not be able to transfer the digital media asset 170 (e.g., if the close proximity transmission 150 is not able to rapidly handle the size of the digital media asset 170). In some embodiments, the data server 110 also facilitates real-time sharing of the digital media assets 170 by receiving the digital media asset 170 from one user mobile device 120 and then serving the digital media asset 170 to another user mobile device 120. However the data server 110 only serves the digital media asset 170 between mobile applications on the user mobile devices 120 once a proximity detection signal has been established between the user mobile devices 120. In other words, the brokerage of the transfer of the digital media asset 170 is only available between close proximity user mobile devices 120, but the data server 110 can then serve the digital media asset 170 stored on the data server 110 to the recipient user mobile device 120. For example, the transfer of the digital media asset 170 between the server 110 and the user mobile devices 120 may be via a faster transmission than the close proximity transmission 150, such as via an online network (e.g., local wi-fi or internet-based network protocols using the devices wireless modem feature).

A close proximity transmission or signal 150 may be sent and/or received by a transceiver located on a user mobile device 120. In some examples, the user mobile device may have a transmitter and a separate receiver. The user mobile device 120 can broadcast the digital media asset (e.g., after the creation of an asset NFT, and optionally via the asset NFT) from the user mobile device 120 using a proximity-based transmission protocol 150. For example, this proximity transmission 150 can be sent via Bluetooth, RFID, Wibree, Ultra-wideband, wireless USB, and/or wireless local area network connections.

The proximity transmission 150 may send a signal over a wireless network to alert other close proximity user mobile devices 120 that a user mobile device 120 is sharing the digital media asset 170. Device data values, hashed values of digital media assets, and digital media assets themselves are exchanged using the close proximity signal 150 or using the close proximity signal 150 and the data server 110 to mitigate any dropped connections or broker data transfers that exceed bandwidth limitations of close proximity transmissions 150.

The recipient user mobile device 120 receives not only the hash value and the digital media asset but also attribution data (e.g., an attribution data string) indicating the authorized owner of the digital media asset (e.g., the creator of the digital media asset 170 initially, or the most recent person to whom ownership was transferred). The recipient user mobile device 120 also injects its own device data values into the attribution data associated with the digital media asset, along with device interaction data (e.g., the date and time of the transfer, or other related meta data). The device interaction data and device data values then link the transmission between user mobile devices 120 together in a data chain (e.g., associated with the digital media asset) that prevents unauthorized viewing or sharing of the asset externally from the mobile applications associated with user mobile devices 120 that are signed into the location-dependent virtual event space 130.

While user mobile devices are present at a local event, they may be paired together using the data associated with the EVENT CODE 140. This pairing permits persistent connections and exchanges of digital media assets to be viewed on participating user mobile devices in real time throughout the local event (i.e., as long as the location-dependent virtual event space is open) via the mobile applications running on the user mobile devices 120.

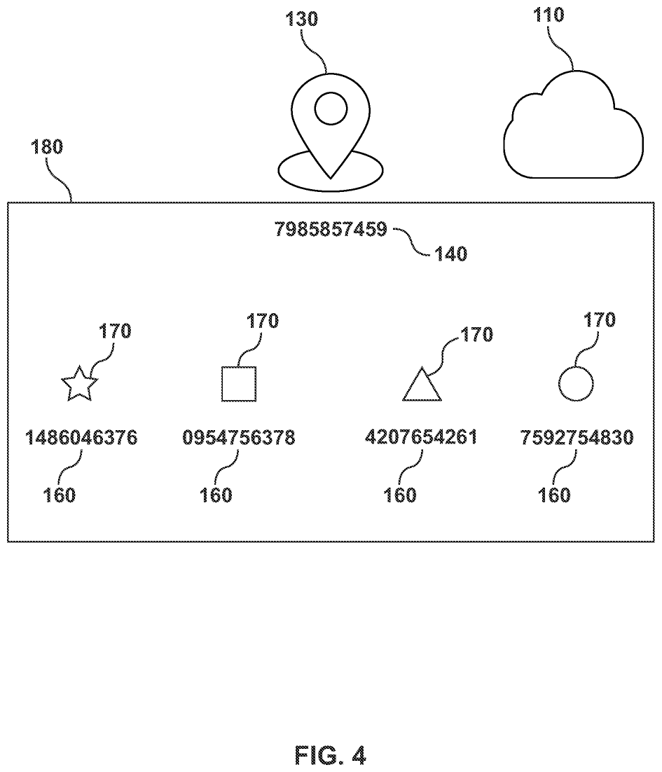

As exemplified in FIG. 4, a collection 180 may be formed of digital media assets 170.

In some embodiments, at the end of the event, all digital assets and the data values related to the user accounts, meta data from the devices, proximity connection data, location and time data values are aggregated together and encrypted using an irreversible encryption algorithm. In some embodiments, this aggregation is conducted by the cloud data server.

The collection 180 may also include user codes 160, the event code 140, device data values, asset hashed values, and/or device interaction data. For example, all aggregated interactions between user mobile devices 120 via the close proximity transmission protocol 150 using the mobile application may be stored by the data server 110 for attribution and auditability of transmissions, and may be part of the collection 180. This collection 180 of can itself be encrypted and hashed to produce a collection hash value.

Ownership of an asset NFT may be given to the user account that was used to create and/or share the associated digital media asset in the location-dependent virtual event space. The collection 180 may be shared with all owners of at least one asset NFT. In other words, a total aggregate of all digital media assets 170 that were shared in the location-dependent virtual event space (e.g., photos and videos of a hockey game or other local event shared in real time with those in attendance at the local event) are shared between participating users who were connected together via the close proximity based wireless transmission 150.

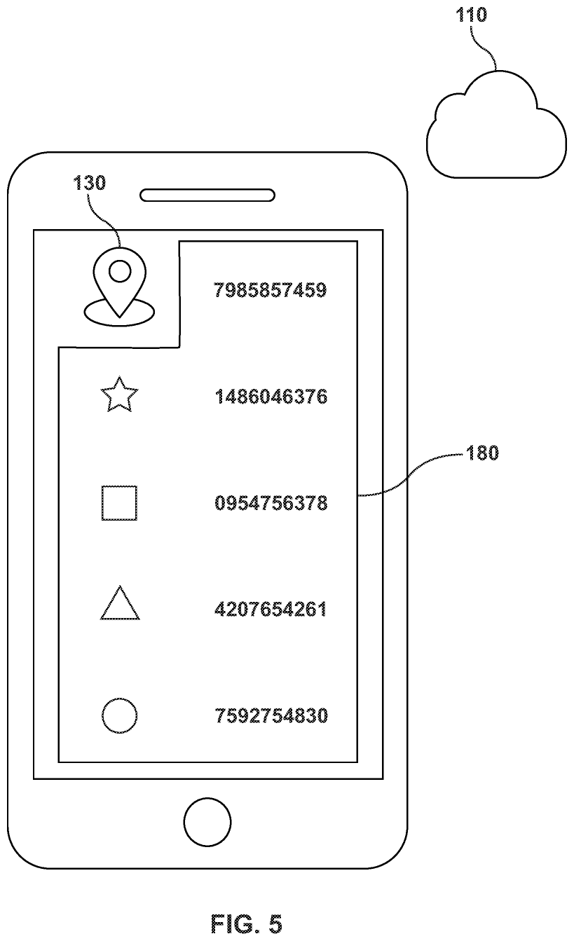

As exemplified in FIG. 5, the owner of an asset NFT may access the collection 180 on a user mobile device 180.

In some embodiments, the final aggregated encrypted event package is sent to each user. In some embodiments, all the combined digital assess shared by each user are visible to every user who participated in the event. In some embodiments, viewing of these digital assets are trackable and can be secured from exploitation or exfiltration from the application by conventional security means such as restricting screen capture. In some embodiments, the event and all digital assets are stored on the cloud server along with all combined data values. In some embodiments, users who view these files are tracked for security and auditability purposes.

In some embodiments, an asset NFT and/or ownership of an asset NFT may be used to sign into a virtual access space to access the collection 180. In some examples, the asset NFTs are transferrable, and the owner of an asset NFT may access the collection 180. The owner of an NFT may access the collection 180 to, e.g., view the digital media assets 170 or interaction data. In some embodiments, the virtual access space permits viewing of digital media assets 170 and/or other data stored in the collection 180 but restricts copying of what is viewed. For example, the virtual access space may prevent downloads and screenshots.

To create this collection NFT (i.e., tokenized data file) the data server 110 takes all the collected digital media assets 170, the device data values, and additional associated data that is collected and aggregated from user mobile devices 120 that signed into the location-dependent virtual event space 130 using the EVENT CODE 140. The hash value in the collection NFT may be a hashed value of all the data in the collection 180.

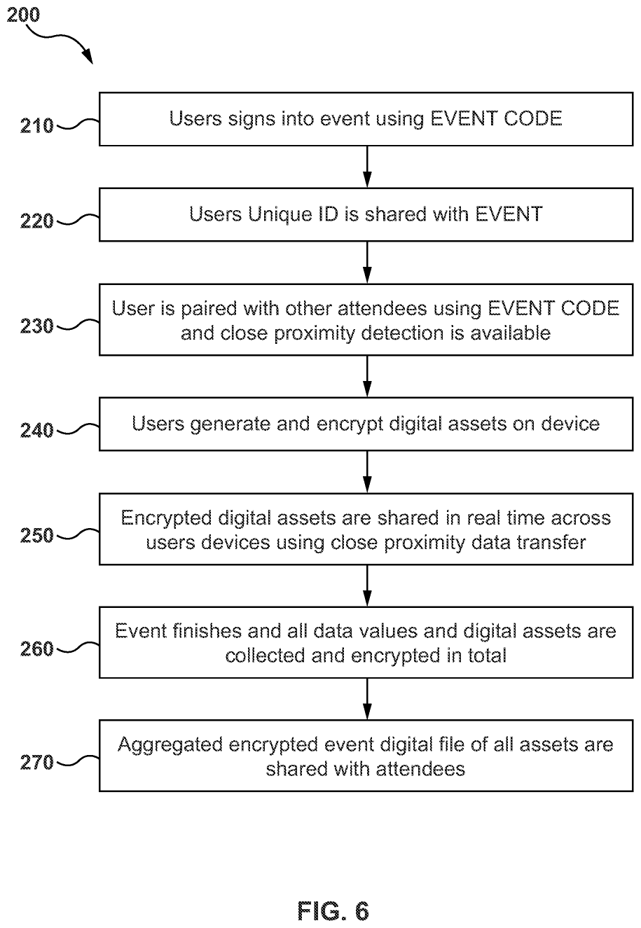

An exemplary method 200 for sharing a local event is illustrated in FIG. 6. The method 200 includes, at step 210, a user signing into an event using an event code. For example, a user may sign into a mobile application on a user mobile device using their user account details, and then access a location-dependent virtual event space using the event code.

The method 200 includes, at step 220, the sharing user's unique identification with the event. For example, device data values and/or user account details may be shared with other user mobile devices and/or the data server hosting the location-dependent virtual event space.

The method also includes, at step 230, the pairing the user with other attendees using the event code and close proximity detection. For example, the user mobile device may be signed into the location-dependent virtual event space and communicatively coupled directly to other user mobile devices via a local wireless network, such as via Bluetooth.

The method 200 also includes, at step 240, a user mobile device generating and encrypting a digital media asset. For example, the user mobile device may use a camera and/or microphone of the user mobile device to capture and audio and/or image (picture or video) recording of the local event, and the user mobile device may generate a hash code from the recording and create an asset NTF. At step 250, the method 200 includes sharing the digital media asset in real time from the user mobile device that created it to another user mobile device that is communicatively coupled via the close proximity signal and is signed into the location-dependent virtual event space.

At step 260, the method includes ending the location-dependent virtual event space and creating a collection of all digital media assets shared in the location-dependent virtual event space. For example, the location-dependent virtual event space may be ended after a few minutes, a few hours, a few days, or a few weeks. The collection may include the digital media assets shared in the location-dependent virtual event space and may include further data such as interactions between mobile devices in the location-dependent virtual event space.

The method 200 also includes, at step 270, creating a collection NFT for the collection and sharing access to the collection with the owners of asset NTFs associated with digital media assets that are included in the collection.

The present invention has been described here by way of example only. Various modification and variations may be made to these examples without departing from the scope of the invention, which is limited only by the appended claims.

1. A method of sharing a local event, comprising:
receiving for each mobile device of a plurality of mobile devices an indication that the mobile device has signed into a location-dependent virtual event space associated with the local event;
receiving for each mobile device of the plurality of mobile device an indication that the mobile device has shared a media asset via the location-dependent virtual event space;
receiving the plurality of media assets and a plurality of asset non-fungible tokens, each asset non-fungible token of the plurality of asset non-fungible tokens representing a media asset of the plurality of media assets, each asset non-fungible token indicative of the media asset it represents and the mobile device from which it originated;
storing the plurality of media assets in a collection; and,
providing access to the collection to an owner of at least one asset non-fungible token of the plurality of non-fungible assets tokens.

2. The method of claim 1, wherein the indication that the mobile device has shared the media asset via the location-dependent virtual event space includes an indication that the mobile device was communicatively coupled via a local wireless connection directly to another mobile device that was signed into the location-dependent virtual event space.

3. The method of claim 2, wherein the local wireless connection is a Bluetooth connection.

4. The method of claim 1, wherein each of the asset non-fungible tokens of the plurality of asset non-fungible tokens incorporates information derived from the media asset it represents.

5. The method of claim 1, wherein each asset non-fungible token is also indicative of the time and place that the media asset it represents was created.

6. The method of claim 1, wherein the owner of the at least one asset non-fungible token is the account holder of a user account controlling the mobile device when the associated media asset was created or a user to whom the at least one asset non-fungible token was transferred by a previous owner.

7. The method of claim 6, wherein ownership records of the asset non-fungible token are stored in a blockchain.

8. The method of claim 1, wherein the content of the collection can be viewed when accessed, but cannot be copied.

9. The method of claim 8, wherein the media assets cannot be copied via download or screenshot.

10. The method of claim 1, wherein the method further comprises generating a collection non-fungible token representing the collection.

11. The method of claim 10, wherein the collection non-fungible token includes information derived from each of the asset non-fungible tokens.

12. A system for sharing a local event, comprising:
a plurality of mobile devices, each configured to:
sign into a location-dependent virtual event space associated with the local event,
connect to others of the plurality of mobile devices directly via a local network at the local event,
create a media asset capturing a view of the local event, and
create an asset non-fungible token representing the media asset and indicative of the media asset and the mobile device that created the media asset;
a data storage device; and,
at least one processor, configured to:
receive for each mobile device of the plurality of mobile devices an indication that the mobile device has signed into the location-dependent virtual event space,
receive for each mobile device of the plurality of mobile device an indication that the mobile device has shared the media asset via the location-dependent virtual event space,
receive the media asset and the asset non-fungible token from each mobile device of the plurality of mobile devices,
store the media assets of the plurality of mobile devices on the data storage device in a collection, and,
provide access to the collection to an owner of at least one asset non-fungible token of the plurality of asset non-fungible tokens.

13. The method of claim 12, wherein the indication that the mobile device has shared the media asset via the location-dependent virtual event space includes an indication that the mobile device was communicatively coupled via a local wireless connection directly to another mobile device that was signed into the location-dependent virtual event space.

14. The method of claim 13, wherein the local wireless connection is a Bluetooth connection.

15. The method of claim 12, wherein each of the asset non-fungible tokens of the plurality of asset non-fungible tokens incorporates information derived from the media asset it represents.

16. The method of claim 12, wherein each asset non-fungible token is also indicative of the time and place that the media asset it represents was created.

17. The method of claim 12, wherein the owner of the at least one asset non-fungible token is the account holder of a user account controlling the mobile device when the associated media asset was created or a user to whom the at least one asset non-fungible token was transferred by a previous owner.

18. The method of claim 17, wherein ownership records of the asset non-fungible token are stored in a blockchain.

19. The method of claim 12, wherein the content of the collection can be viewed when accessed, but cannot be copied.

20. The method of claim 19, wherein the media assets cannot be copied via download or screenshot.

21. The method of claim 12, wherein the at least one processor is further configured to generate a collection non-fungible token representing the collection.

22. The method of claim 21, wherein the collection non-fungible token includes information derived from each of the asset non-fungible tokens.
